(19) United States
(12) Patent Application Publication
(10) Pub. No.: US 2004/0155789 A1
(43) Pub. Date: Aug. 12, 2004

(54) Instrument display providing a plurality of data sets

(76) Inventor: John T. Crews, Dallas, TX (US)

Correspondence Address: Michael L. Diaz, Michael L. Diaz, P.C., 555 Republic Drive, Suite 200, Plano, TX, 75074, US

(21) Appl. No.: 10/360,967

(22) Filed: Feb. 7, 2003

(51) Int. Cl. G08B 5/00

(52) U.S. Cl. 340/815.86

(57) ABSTRACT

A display simultaneously providing two sets of data. The display includes a moveable needle rotated about a pivot point located at the base of the length of the needle. The position of the needle upon a background provides an indication of a first set of data. The needle may also be incrementally illuminated or highlighted to indicate a measured value of a second set of data. The illumination may be a plurality of lights affixed to the length of the needle. Additionally, the lights may optionally be color coded to indicate a specific range value.

### BACKGROUND OF THE INVENTION

1. Technical Field of the Invention

This invention relates to instrument displays, and more particularly, to an instrument display providing at least two sets of data sets to an operator.

2. Description of Related Art

Over recent years, the use of displays has progressed with the advancements in technology, specifically in microelectronics. Displays assist operators of various types of equipment to determine the status of the equipment that they operate. In particular, vehicles have utilized numerous types of instruments to present information to a driver. For example, in most vehicles, the driver is provided with a speedometer, tachometer, an oil pressure indicator, and a water temperature indicator. Typically, each instrument is devoted to a separate type of data for assimilation by the driver. For instance, the driver must specifically check the speedometer to determine the speed of the vehicle, while separately checking the tachometer to determine the RPM of the engine. It is quite common that the vehicle employs analog displays, such as moving needles to present the information to the driver.

However, in recent years, vehicles have been equipped with monochrome digital displays which provide information as digital discrete numerical values, or with bars to indicate the relative numerical value. However, these digital displays suffer from several disadvantages. In order for the driver to assimilate the information presented in a digital display, the driver must devote a significant amount of his attention to the display. The driver must observe the numerical value and determine the meaning of the symbol. When driving a fast speed, the driver does not always have ample time to devote the attention required to perceive and absorb the information presented on the digital display. An instrument display is needed which enables an operator to absorb the presented information in a simple and rapid manner.

Although there are no known prior art teachings of an apparatus such as that disclosed herein, prior art references that discuss subject matter that bears some relation to matters discussed herein are U.S. Pat. No. 5,815,072 to Yamanaka et al. (Yamanaka), U.S. Pat. No. 6,140,917 to Branson, and U.S. Pat. No. 6,429,845 to Unseld et al. (Unseld).

Yamanaka discloses a vehicle display, such as a speedometer, which includes indicators having multiple segments illuminated in two or more colors by a plurality of LEDs and an indicator control circuit. The indicators dispose the segments so as to display information, such as a car speed in a bar graph or a form of a number. The indicator control circuit displays the variable by controlling the lighting of the LEDs and changes an emitted light color of indication based on a fixed color changing reference value. However, Yamanaka does not teach or suggest an instrument display which provides at least two separate sets of information. Yamanaka merely discloses an instrument display which varies the color of the display in accordance with the value of the single set of information.

Branson discloses an instrument display having a face with a measurement indicia and a pointer rotatably mounted to the face. The face has a zoned area of a different color than a remainder of the face. The zoned area extends over an area of the instrument face corresponding with a limit of the measurement indicia. The pointer also has a shape with an area greater than the zoned area. However, Branson merely discloses a display which provides an indicator when a range or limit has been exceeded. Branson does not provide at least two separate sets of information on the display.

Unseld discloses a process for displaying several sets of information with different display priorities on a display panel. The display has a symbol which is presented on the display panel for information with high display priority, starting from the time of occurrence of a specific condition, and changed by an operator. However, Unseld does not teach or suggest the simultaneous display of two different sets of information on a single display.

Review of the foregoing references reveals no disclosure or suggestion of a display which simultaneously presents two sets of information on one display which is easily assimilated by an operator. It is an object of the present invention to provide such an apparatus.

### SUMMARY OF THE INVENTION

In one aspect, the present invention is a display providing a plurality of data sets. The display includes a moveable needle and a background having a plurality of indicia presenting a plurality of values associated with a first set of data. The needle moves to a first measured value of the plurality of values on the background. The needle also has a plurality of lights located on a length of the needle. The plurality of lights incrementally illuminate to indicate a second measured value for a second set of data. The needle simultaneously provides an indication of the first measured value from the first set of data and the second measured value from the second set of data.

In another aspect, the present invention is a display providing at least two sets of data to an operator. The display includes a background having a plurality of segmented lines for indicating a first measured value from a first set of data and a moveable indicia which moves to a location in a vicinity of one of the plurality of segmented lines to provide an indication of the first measure value. The moveable indica has a second indicator which indicates a second measured value from a second set of data. The moveable indicia simultaneously provides an indication of the first and second measured values.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a front view of an instrument display in the preferred embodiment of the present invention;

FIG. 2 is a front view of the needle on the display illustrating different values than shown in FIG. 1;

FIG. 3 is a front view of a monochrome display in an alternate embodiment of the present invention; and

FIG. 4 is a front view of the display showing the illumination of the needle for a length.

### DETAILED DESCRIPTION OF EMBODIMENTS

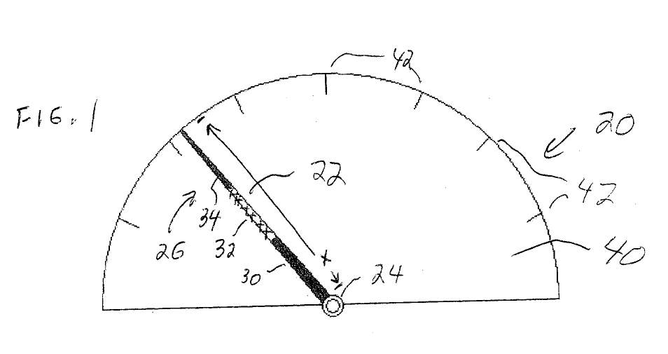

A display which simultaneously provides at least two sets of data on the display is disclosed. FIG. 1 is a front view of an instrument display 20 in the preferred embodiment of the present invention. The display 20 provides an analog presentation of a first set of data, such as a speedometer indicating a speed of a vehicle. The display includes a moveable needle 22, which preferably rotates about a pivot point 24. As the measured value is sensed by control circuit (not shown) within the display increases, the needle rotates clockwise.

The needle 22 includes a plurality of colored or monochrome segments 26 affixed along a substantial length X of the needle. The segments may be highlighted or illuminated in a wide variety of ways, such as light emitting diodes (LEDs), liquid crystal displays (LCD), one or more fiber optic strands. A second set of data is presented on the highlighted/illuminated needle. For example, the RPM (tachometer range) may be indicated upon the illuminated needle. As shown in FIG. 1, the needle includes three segments 30, 32, and 34. When the second set of data reaches a specific threshold, all or a portion of the first segment 30 is illuminated. If a second threshold value is reached, all or a portion of the second segment 32 is illuminated. When a third threshold value is reached, all or a portion of the third segment 34 is illuminated. The incremental illumination/highlighting of the segments provide a simple presentation to the viewer and allows ease of assimilation of the information. Each segment may also be identified with a coded color of light. For example, segment 30 may be green, segment 32 may be yellow, and segment 34 may be red. The use of multiple colors enables a viewer to easily determine a specific range of the second set of data while still permitting the viewer to determine the value of the first set of data from the position of the needle. It should be understood that any manner of presenting the second set of data on the needle may be utilized.

A background 40 of the display provides a relative measurement indicator for the first set of data. As illustrated in FIG. 1, the background includes a plurality of segmented lines 42 to indicate a specific discrete value for the first set of data. As the needle 22 is rotated to a specific position on the background, the viewer may determine the value of the first set of data. As illustrated in FIG. 1, the needle indicates a value slightly beyond a second segmented line 42. In addition, the needle indicates a value of a second set of data above a third threshold value.

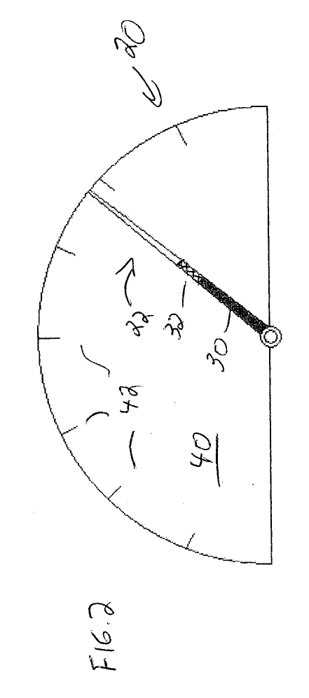

FIG. 2 is a front view of the needle 22 on the display 20 illustrating different values for the first and second sets of data than illustrated in FIG. 1. As shown, the needle is positioned slightly below the sixth segmented line 42. In addition, the needle shows the illumination of the first segment 30 and a portion of the second segment 32.

With reference to FIGS. 1 and 2, the operation of the display 20 will now be explained. The display 20 may be utilized to measure two sets of data. The example of a vehicle shall be used, although it should be understood that the display is not limited to the use of vehicles. The display may measure the speed of the vehicle, where the rotatable needle 22 provides an indication by the position of the needle against the background 42, as utilized by conventional speedometers. Therefore, if the speed of the vehicle increases, the position of the needle is incrementally rotated about the pivot point 24 with a point 50 of the needle lining up with one of the segmented lines 42. The driver may then ascertain the speed of the vehicle by quickly glancing at the speedometer. The analog display has been shown to be much more easily assimilated by the driver than a digital display.

The display may also provide a second set of data, such as an indicator of the RPM of the engine. The needle is incrementally illuminated or highlighted as the RPM is increased. Thus, as the RPM of the engine goes from rest to a first preset value, the first segment 30 of the needle is illuminated (which may be illuminated in a specific color, such as green). As the RPM increases, the needle is incrementally illuminated. When a second preset value is reached, the second segment may be illuminated a second color, such as yellow. As the RPM further increases, the third segment is incrementally illuminated a third color, such as red. By utilizing an analog display with the incremental illumination of segments of lights, the driver may quickly ascertain the relative values of two sets of information.

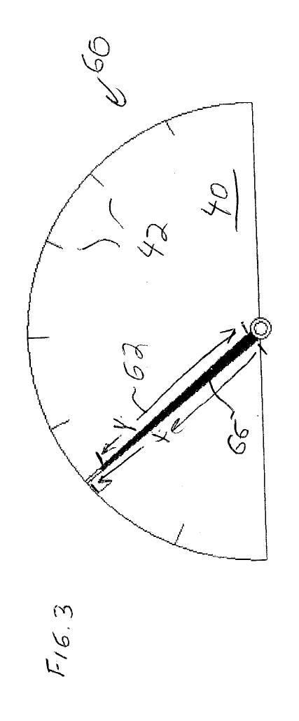

FIG. 3 is a front view of a monochrome display 60 in an alternate embodiment of the present invention. The display 60 includes a needle 62, a background 40, and a plurality of segmented lines 42. The needle includes a plurality of monochrome lights 66 running the length X of the needle 22.

The needle 62 is rotated about the pivot point 24 and provides an indication of a first set of data. The plurality of monochrome lights are incrementally illuminated to provide a second set of data. As illustrated in FIG. 3, the needle is illuminated a substantial length Y of the needle.

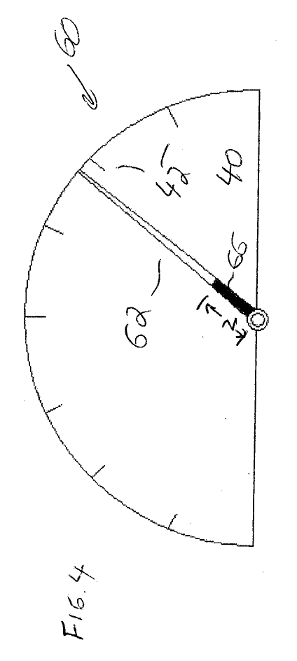

FIG. 4 is a front view of the display 60 showing the illumination of the needle 62 for a length Z. The needle has been rotated clockwise to a position indicating a greater value for the first set of data from that indicated in FIG. 3. In addition, the needle is illuminated the length Z, showing a lesser value for the second set of data than the value indicated in FIG. 3.

With reference to FIGS. 3 and 4, the operation of the display 60 will now be explained. For illustrative purposes only, the display may be an indicator for a vehicle where the first set of data is the RPM of the motor of the vehicle and the second set of data is the oil pressure of the motor. In FIG. 3, the needle is positioned against the background to indicate an RPM value. Note that the position of the needle is slightly greater than the second segmented line 42. In addition, the needle is illuminated by a series of monochrome lights running up the length of the needle 62. As illustrated in FIG. 3, the needle is illuminated a length Y. The length Y indicates the relative value of the oil pressure.

FIG. 4 illustrates the needle in a second position, where the needle is slightly below the sixth segmented line 42. In addition, the needle 62 is illuminated the length Z, showing a relative value of oil pressure less than illuminated in FIG. 3.

The present invention may be utilized on any equipment requiring the simultaneous display of two sets of information. The present invention is particularly effective for use on vehicles, water craft, and aircraft because it provides a unique manner to display the two sets of information to the operator which can easily and quickly be assimilated. The display may be a conventional display having an actual movable needle or the display may be a generated visual display, such as generated upon a LCD display. However, the display requires an analog display of a needle and the illumination of the needle.

The needle may be illuminated in any fashion which provides a secondary indicator for the second set of data. The display may display such primary indicators, such as a speedometer vs. engine RPM, gear ratio, and acceleration/deceleration. Additionally, the display may indicate a primary set of data, such as tachometer vs. manifold pressure, oil pressure and upshifting/downshifting. However, the display may also simultaneously indicate any two discrete sets of data. Additionally, by use of color coded lights, the display may provide a third set of data. However, the color coded lights may also be a redundant indicator of a range of the second set of data.

The present invention provides many advantages over existing displays. The present invention enables an operator to quickly and easily ascertain two sets of information simultaneously. Additionally, the display may be color coded to display a third set of data, if required. The present invention may enhance the safety of the operation of vehicles, water craft, and aircraft requiring the operator to quickly assimilate two or more sets of data.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

What is claimed is:

1. A display providing a plurality of data sets, said display comprising:
a moveable needle; and
a background having a plurality of indicia presenting a plurality of values associated with a first set of data;
said needle moving to a first measured value of the plurality of values on said background;
said needle having a plurality of lights located on a length of said needle, said plurality of lights incrementally illuminating to indicate a second measured value for a second set of data;
whereby said needle simultaneously provides an indication of the first measured value from the first set of data and the second measured value from the second set of data.

2. The display providing a plurality of data sets of claim 1 wherein said moveable needle is rotated about a point located on a base of said background, said needle moving incrementally to positions in a vicinity of the plurality of indicia.

3. The display providing a plurality of data sets of claim 1 wherein said plurality of lights are color coded.

4. The display providing a plurality of data sets of claim 3 wherein said plurality of lights are segmented into a plurality of ranges of the second set of data, each range being associated with a specified color.

5. The display providing a plurality of data sets of claim 1 wherein said moveable needle provides an analog representation of the first set of data.

6. The display providing a plurality of data sets of claim 1 wherein the plurality of lights are a plurality of light emitting diodes (LEDs).

7. The display providing a plurality of data sets of claim 1 wherein the plurality of lights is a plurality of liquid crystal displays (LCDs).

8. A display providing at least two sets of data to an operator, said display comprising:
a background having a plurality of segmented lines for indicating a first measured value from a first set of data; and
a moveable indicia which moves to a location in a vicinity of one of the plurality of segmented lines to provide an indication of the first measure value;
said moveable indicia having a second indicator having means for indicating a second measured value from a second set of data;
whereby said moveable indicia simultaneously provides an indication of the first and second measured values.

9. The display providing at least two sets of data of claim 8 wherein said moveable indicia is displayed on a video presentation system.

10. The display providing at least two sets of data of claim 9 wherein the video presentation system is a cathode ray tube display.

11. The display providing at least two sets of data of claim 8 wherein the means for indicating a second measured value is a plurality of lights incrementally illuminated to indicate a second measured value from the second set of data.

12. The display providing at least two sets of data of claim 8 wherein the plurality of lights are a plurality of light emitting diodes (LEDs).

13. The display providing at least two sets of data of claim 8 wherein the plurality of lights is a plurality of liquid crystal displays (LCDs).

14. The display providing at least two sets of data of claim 8 wherein the plurality of lights is a fiber optic strand.

15. The display providing at least two sets of data of claim 8 wherein the means for indicating a second measured value includes a color coding system whereby the second measured value is further defined by a plurality of ranges of the second set of data, each range being associated with a specified color.

16. The display providing at least two sets of data of claim 8 wherein the means for indicating a second measured value is a monochrome illumination displayed upon the moveable indicia, the monochrome illumination incrementally increasing over a length of the moveable indicia.
